(19) United States
(12) Patent Application Publication
(10) Pub. No.: US 2026/0286918 A1
(43) Pub. Date: Sep. 24, 2026

(54) METHOD FOR OPERATING A TANK UNIT, AND TANK UNIT FOR STORING A GASEOUS FUEL

(71) Applicant: Robert Bosch GmbH, Stuttgart (DE)

(72) Inventors: Stefan Kieferle, Stuttgart (DE); Christian Kuhnert, Vaihingen/Enz (DE); Markus Strasser, Stuttgart (DE)

(21) Appl. No.: 19/148,735

(22) PCT Filed: Jan. 9, 2024
(86) PCT No.: PCT/EP2024/050370

§ 371 Date: Jul. 17, 2025

(30) Foreign Application Priority Data
Jan. 20, 2023 (DE) 10 2023 200 444.5

(51) Int. Cl. F02M 21/02; F17C 13/02

(52) U.S. Cl. CPC F02M 21/0239; F02M 21/0206; F02M 21/0221; F02M 21/0293; F17C 13/021; F17C 13/025; F17C 13/026; F17C 2221/012

(57) ABSTRACT

The present invention provides a method for operating a tank unit (1) in which a control device (SE) with sensor devices (Si) is used to ascertain a gas pressure in a gas line system (GL) and to ascertain a gas temperature in at least one or more tank vessels (TB), wherein the one or more tank vessels (TB) are connected to the gas line system (GL), wherein the control device ascertains a fill level of the tank vessels on the basis of the sensor devices only after at least one corresponding enabling criterion has been reached after a valve mechanism on the tank vessel or on a plurality of tank vessels has been opened, wherein the fill level of the respective tank vessel is ascertained from the gas temperature in the respective tank vessel and from the gas pressure of the gas line system (GL).

### BACKGROUND

The present invention relates to a method for operating a tank unit, and a tank unit for storing a gaseous fuel.

Safety mechanisms and/or valves may be installed in known pressure storage tanks. Fuel cell systems having tank assemblies or tanks for gaseous media are known for this purpose. Pressure storage tanks may be equipped with a valve to isolate or discharge the tank contents.

In conventional H2 tank systems with a plurality of gas tanks, each equipped with its own tank valve, not necessarily all tanks are equipped with their own pressure sensor. It is desirable to ascertain the fill level of the tank and, in the case of a plurality of tanks, after pressure equalization has been reached.

DE112006003013B4 describes a tank with a fitting and a valve, wherein the valve is fastened in the fitting.

### SUMMARY

The present invention provides a method for operating a tank unit, and a tank unit for storing a gaseous fuel.

Preferred developments are the subject-matter of the subordinate claims.

The underlying idea of the present invention is to provide a method for operating a tank unit, and a tank unit for storing a gaseous fuel, in which a state of charge (SOC) of the tank unit may be ascertained more accurately.

Advantageously, an avoidance and/or reduction of inaccuracies in determining the fill level in one or several tank vessels during operation and after vehicle start-up, such as in a fuel cell vehicle, under varying tank pressures, for example, as a result of different tank heating or cooling during vehicle idle periods, may be achieved.

According to the invention, a determination of a gas pressure in a gas line system and a determination of a gas temperature in at least one or more tank vessels is carried out in the method for operating a tank unit by a control device with sensor devices, wherein the one or more tank vessels are connected to the gas line system, wherein the control device ascertains a fill level of the tank vessels on the basis of the sensor devices only after at least one corresponding enabling criterion has been reached after an opening of a valve mechanism on the tank vessel or on a plurality of tank vessels, wherein the fill level of the respective tank vessel is ascertained from the gas temperature in the respective tank vessel and from the gas pressure of the gas line system.

According to a preferred embodiment of the method, the enabling criterion is met after a predetermined time has elapsed after opening of the at least one valve mechanism on the tank vessel.

According to a preferred embodiment of the method, the enabling criterion is met after opening of the at least one valve unit on the tank vessel by an ascertained pressure gradient corresponding to an expected pressure gradient, taking into account a permissible deviation in the gas line system, wherein the pressure gradient in the gas line system is ascertained and, when determining the expected pressure gradient, the following variables are taken into account individually or in combination: withdrawal mass flow of the consumer, tank volume, gas temperatures in the tanks, line pressure, ambient temperature.

According to a preferred embodiment of the method, the enabling criterion is met after opening of the at least one valve mechanism on the tank vessel by ascertained temperature gradients corresponding to the expected temperature gradients, taking into account a permissible deviation in the respective tank vessels, wherein the temperature gradients in the tank vessels are ascertained and, when determining the expected temperature gradients for the gas in the individual tank vessels, the following variables are taken into account individually or in combination: withdrawal mass flow of the consumer, tank volume of one or all tank vessels, gas temperatures in the tanks, line pressure, ambient temperature.

According to a preferred embodiment of the method, the enabling criterion is met after opening of the at least one valve mechanism on the tank vessel, by a pressure equalization between the respective tank vessels being ascertained, wherein when determining the pressure equalization for the individual tank vessels, the individual tank pressures are measured by corresponding sensors, and the difference between the highest tank pressure and the lowest tank pressure is less than a predetermined value.

According to a preferred embodiment of the method, the method further comprises detecting an opening of the at least one valve mechanism; ascertaining a gas pressure in the gas line system, and ascertaining the gas temperature in the at least one tank vessel with the sensor device after reaching at least one corresponding enabling criterion after opening of the valve mechanism; and calculating a state of charge of the entire gas storage system from the ascertained gas pressure in the gas line system, the ascertained gas temperatures in the individual tank vessels, and the respective volume of the individual tank vessels.

According to the invention, the tank unit for storing a gaseous fuel comprises at least one tank into which the gaseous fuel is fillable; at least one valve mechanism per tank vessel, which is connected to or located on the tank vessel, wherein the valve mechanism is configured to allow and/or drain the gaseous fuel into the at least one tank vessel and/or separate the tank contents; a gas line in a gas line system connected to the at least one valve mechanism; a control device with a sensor device by means of which a method according to the invention may be carried out, which is connected to or located in the gas line and the at least one tank vessel, and is configured to determine a gas pressure in the gas line and a gas temperature in the at least one tank vessel.

The one or more tank vessels, together with the gas line system, may constitute a gas storage system.

According to a preferred embodiment of the tank unit, the control device is configured to count the predetermined time only after the valve mechanisms on the tank vessels have been opened.

According to a preferred embodiment of the tank unit, said tank unit comprises a plurality of tank vessels, which are connected to the gas line and to the sensor device, wherein after the predetermined time after opening of the valve mechanisms on the tank vessel, the internal pressures of the tank vessels are equalizable to each other within a tolerance interval.

According to a preferred embodiment of the tank unit, the control device is configured to open the valve mechanisms of the tank vessels.

The gas line system may serve to supply the gaseous fuel to the tank vessels and also to evacuate the gas from the tanks to the engine or fuel cell of the vehicle. The valve mechanism may comprise a closable valve, which may be electrically opened and closed. Pressure equalization between the tanks may be achieved by opening the tank valves and releasing gas to the supply line to the gas pipe system. The predetermined time until the assumed pressure equalization may be so long that a gas pressure in the gas line system and the tank vessels may be equalized when several tank vessels are opened after an operational start of the vehicle's drive, such as the function of the fuel cell or the engine. This means that high internal pressure in one tank may release more gas fuel to the gas line than low internal pressure in another tank until the internal pressures are equalized, at which point both (or several) may release the same amounts per unit of time.

The vehicle may be a fuel cell vehicle. The gaseous fuel may be a gaseous gas for the operation of a fuel cell, for example, hydrogen or also other gases that are suitable for this purpose. On the other hand, the gaseous fuel may also be a gas for a gas-powered vehicle, such as CNG or LPG, which may also be liquid gas.

The sensor device may comprise one or more sensors with which a reduction in pressure, and/or a pressure gradient, and/or a temperature gradient, and/or a temperature in the tank vessel or the gas line system may be detected.

The control device may be connected to, and read out, the valve mechanism of one or more tank vessels and sensors.

The method may be used to achieve an optimized tank level determination after a vehicle has stopped. The tank unit may be used in a hydrogen tank system and supply hydrogen to a fuel cell.

According to a preferred embodiment of the method, the control device is configured to count the predetermined time until pressure equalization in the entire storage system only after a fuel cell has been started up; advantageously, after the switching valves have been opened in the vehicle.

The one or more tank vessels are connected to the gas line system, for example, by supply lines that open into the gas line system. The supply lines may be connected to the valve mechanisms of the respective tank vessels.

In general, the tank fill level of the entire gas storage system (all tank vessels and the gas pipe system) may be ascertained after concluding that the gas storage system is pressure-balanced based on the pressure curve in the gas pipe system over time.

The method may also be characterized by the features and advantages mentioned in connection with the tank unit and vice versa.

Further features and advantages of embodiments of the invention are apparent from the following description with reference to the accompanying drawings.

### BRIEF DESCRIPTION OF THE DRAWINGS

The present invention is explained in greater detail below with reference to the exemplary embodiments indicated in the figures of the drawing.

Shown are:

FIG. 1 a schematic representation of a tank unit for storing a gas fuel according to an exemplary embodiment of the present invention.

### DETAILED DESCRIPTION

Identical reference signs in the figures denote identical or functionally identical elements.

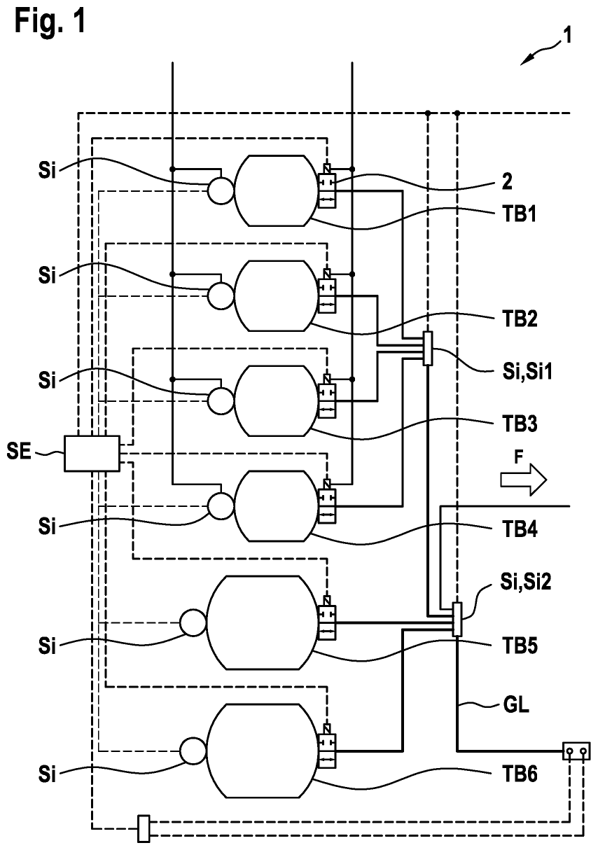

According to FIG. 1, the tank unit 1 for storing a gas fuel for a vehicle comprises a plurality of tank vessels TB1, TB2, TB3, TB4, TB5 and TB6, for example, cylinders filled or fillable with hydrogen. The tank unit 1 comprises a valve mechanism 2, for example, for each tank vessel, which is connected to or located on the tank vessel, wherein the valve mechanism 2 is configured to admit and/or discharge the gas fuel into the tank vessels and/or to separate their tank contents. The tank unit 1 further comprises a gas line GL in a gas line system, which is connected to the at least one valve mechanism 2; and a control device SE with a sensor device Si by means of which a method according to the invention can be carried out, which is connected to or located in the gas line GL and the at least one tank vessel and is configured to ascertain a gas pressure in the gas line GL and a gas temperature in the at least one tank vessel.

A temperature sensor Si may be present on each of the tank vessels TB1 to TB6, which may be connected to the control unit SE and may be read out by it. A tank temperature of the respective tank vessel may be ascertained by the respective temperature sensor.

The sensor device Si may also comprise several sensors, for example, a first sensor Si1, which may be connected to supply lines from the first three tank vessels (for example, three, although this arrangement may also be different), and a second sensor Si2, which may be connected to the remaining supply lines and the gas line GL, and is configured to ascertain a gas pressure in the gas line GL at a predetermined time. The method according to the invention for ascertaining pressure, pressure gradient, or further parameters may be carried out on one or both or further sensors. The control device SE may be configured to count the predetermined time only after the vehicle has been put into operation and/or to open the valve mechanisms 2 of the tank vessels (TB1, TB2, TB3, . . . ) after the vehicle has been put into operation.

Although the present invention has been described in its entirety above in accordance with the preferred exemplary embodiment, it is not limited thereto, but is modifiable in a variety of ways.

1. A method for operating a tank unit (1), in which a control device (SE) with sensor devices (Si) is used to determine a gas pressure in a gas line system (GL), and to determine a gas temperature in at least one or more tank vessels (TB), wherein the one or more tank vessels (TB) are connected to the gas line system (GL), wherein the control device determines a fill level of the tank vessels based on the sensor devices only after at least one corresponding enabling criterion has been reached after a valve mechanism on the tank vessel or on a plurality of tank vessels has been opened, wherein the fill level of the respective tank vessel is determined from the gas temperature in the respective tank vessel and from the gas pressure of the gas line system (GL).

2. The method according to claim 1, in which the enabling criterion is met after a predetermined time has elapsed after opening of the at least one valve mechanism on the tank vessel.

3. The method according to claim 1, in which the enabling criterion is met after opening the at least one valve mechanism on the tank vessel, by an determined pressure gradient corresponding to an expected pressure gradient, taking into account a permissible deviation in the gas line system, wherein the pressure gradient is determined in the gas line system, and when determining the expected pressure gradient at least on selected from group of variables consisting of withdrawal mass flow of a consumer, tank volume, gas temperatures in the tanks, line pressure, and ambient temperature is taken into account.

4. The method according to claim 1, in which the enabling criterion is met after opening of the at least one valve mechanism on the tank vessel by determined temperature gradients corresponding to an expected temperature gradients, taking into account a permissible deviation in the respective tank vessels, wherein the temperature gradients in the tank vessels are determined and, when determining the expected temperature gradients for the gas in individual tank vessels, at least one selected from the group consisting of withdrawal mass flow of a consumer, tank volume of one or all tank vessels, gas temperatures in the tanks, line pressure, and ambient temperature is taken into account.

5. The method according to claim 1, in which the enabling criterion is met after opening of the at least one valve mechanism on the tank vessel by determining a pressure equalization between the respective tank vessels, wherein, when determining the pressure equalization for individual tank vessels, the individual tank pressures are measured by corresponding sensors and a difference between a highest tank pressure and a lowest tank pressure is less than a predetermined value.

6. The method according to claim 1, further comprising:
detecting an opening of the at least one valve mechanism
determining a gas pressure in the gas line system and
determining the gas temperature in the at least one tank vessel (TB) with the sensor device (Si) after reaching at least one corresponding enabling criterion after opening the valve mechanism
determining a state of charge of the entire gas storage system from the determined gas pressure in the gas line system, the determined gas temperatures in individual tank vessels, and a respective volume of the individual tank vessels.

7. The tank unit (1) for storing a gas fuel, comprising:
at least one tank vessel (TB) into which the gas fuel may be filled;
at least one valve mechanism (2) per tank vessel, which is connected to or located on the tank vessel (TB), wherein the valve mechanism (2) is configured to admit and/or discharge the gas fuel into the at least one tank vessel (TB) and/or to separate off a tank contents;
a gas line (GL) in a gas line system, which is connected to the at least one valve mechanism (2);
a control device (SE) with a sensor device (Si) by means of which a method according to claim 1, may be carried out, which is connected to or located in the gas line (GL) and the at least one tank vessel and is configured to determine a gas pressure in the gas line (GL) and a gas temperature in the at least one tank vessel.

8. The tank unit (1) according to claim 7, in which the control device (SE) is configured to count a predetermined time only after the valve mechanisms on the tank vessels have been opened.

9. The tank unit (1) according to claim 7, comprising a plurality of tank vessels (TB1, TB2, TB3, . . . ) which are connected to the gas line (GL) and to the sensor device (Si), wherein after a predetermined time after opening of the valve mechanisms on the tank vessels, internal pressures of the tank vessels (TB1, TB2, ,TB3, . . . ) are equalizable to each other within a tolerance interval.

10. The tank unit (1) according to claim 9, in which the control device (SE) is configured to open the valve mechanisms (2) of the tank vessels (TB1, TB2, TB3, . . . ).
